(19) United States
(12) Patent Application Publication
(10) Pub. No.: US 2011/0035704 A1
(43) Pub. Date: Feb. 10, 2011

(54) INFORMATION PROCESSING DEVICE, OPERATION CONTROL SYSTEM, AND COMPUTER READABLE RECORDING MEDIUM WITH SCREEN DATA GENERATION PROGRAM RECORDED THEREON

(75) Inventors: Tetsuya Nishino, Osaka-shi (JP); Rie Kasai, Osaka-shi (JP); Shingo Ueno, Osaka-shi (JP)

Correspondence Address: HESPOS & PORCO LLP, 110 West 40th Street, Suite 2501, NEW YORK, NY, 10018, US

(73) Assignee: KYOCERA MITA CORPORATION, Osaka-shi (JP)

(21) Appl. No.: 12/850,734

(22) Filed: Aug. 5, 2010

(30) Foreign Application Priority Data
Aug. 6, 2009 (JP) 2009-183919

(51) Int. Cl. G06F 3/048

(52) U.S. Cl. 715/810

(57) ABSTRACT

An information processing device configured from either a PC or a web server, or from both a PC and a web server, including a command response unit for analyzing an item group associated with display target parts shown with a parts selection command received from a multifunction machine, and a communication unit for outputting the analyzed item group to the multifunction machine and receiving, from the multifunction machine, an operation setting accepted by the multifunction machine. The command response unit deems that an acceptable item to become a prohibition target based on the operation setting accepted by the communication unit has been excluded from the item group associated with the display target parts.

### BACKGROUND OF THE INVENTION

1. Field of the Invention

The present invention generally relates to an information processing device, an operation control system, and a computer readable recording medium with a screen data generation program recorded thereon, and in particular relates to technology for generating screen data to be displayed as a display screen on a display unit provided to an electrical apparatus.

2. Description of the Related Art

With an electrical apparatus such as an image forming apparatus that receives a command from a user and performs operations according to such command, conventionally, a display unit configured from an LCD (Liquid Crystal Display) or the like is provided to an operation panel on the front face of the apparatus, and technology is being adopted for accepting an operation execution command from a user corresponding to the respective operation buttons in the display screen displayed on the display unit based on the touch panel function provided to the display unit.

When displaying a display screen on the display unit as with the foregoing image forming apparatus, it is desirable that a customized display screen with the user's intended operation buttons and layout thereof can be freely displayed on the display unit. Here, it is desirable that the operations to be performed upon customizing the operation buttons of the display screen and the layout thereof is simple for a developer (hereinafter referred to as the “operator”) to perform such customization operations.

### SUMMARY OF THE INVENTION

The present invention allows an operator to create a customized display screen according to one's intended operation buttons and the layout thereof with an easy operation.

Specifically, the present invention is an information processing device for generating screen data to be displayed as a display screen on a display unit provided to an electrical apparatus, including: a group item value storage unit for storing item groups each including one or more acceptable items to be displayed on the display unit for accepting an operation command from a user when an operational image to be displayed on the display screen of the display unit is operated by a user; an item group selection acceptance unit for accepting a designation of an item group selected by an operator among the item groups stored in the group item value storage unit; a display target parts building unit for building display target parts by associating the item group accepted by the item group selection acceptance unit with the operational image; a parts selection command reception unit for receiving, from the electrical apparatus, a parts selection command showing the display target parts selected by a user with the electrical apparatus; an analysis unit for analyzing the item group associated with the display target parts shown with the parts selection command received by the parts selection command reception unit based on the association of the operational image and the item group configuring the display target parts built with the display target parts building unit; an output unit for outputting the item group analyzed with the analysis unit to the electrical apparatus; and an operation setting reception unit for receiving, from the electrical apparatus, an operation setting that has been accepted based on a user's operation of the acceptable item with the electrical apparatus, wherein the group item value storage unit stores, for each of the item groups, an acceptable item to become a prohibition target of display according to a combination of the operation setting received with the operation setting reception unit and the item group, and, when the operation setting is accepted by the operation setting reception unit, the analysis unit deems that the acceptable item to become the prohibition target based on the operation setting has been excluded from the item group associated with the display target parts according to information of the acceptable item to become the prohibition target stored in the group item value storage unit.

### BRIEF DESCRIPTION OF THE DRAWINGS

FIG. 1 is a diagram showing a configuration that is required for the generation/display processing of a display screen and the operation control of a web server, a personal computer and an image forming apparatus provided to an operation control system.

FIG. 2 is a conceptual diagram showing the screen display processing and operation control in the operation control system.

FIG. 3 is a diagram showing the processing during the display screen creation by the PC and the web server.

FIG. 4 is a diagram showing an example of the customization acceptance screen.

FIG. 5 is a diagram showing an example of the customization acceptance screen.

FIG. 6 is a diagram showing an example of the item group name list screen.

FIG. 7 is a flowchart showing the display processing of the display screen based on the display unit of the multifunction machine using the generated screen data and the operation execution control of the multifunction machine based on the operation execution command from the user to be performed by the operation control system.

FIG. 8 is a diagram showing an example of the display screen.

FIG. 9 is a diagram showing an example of the display screen.

FIG. 10 is a diagram showing an example of the display screen.

### DETAILED DESCRIPTION OF THE PREFERRED EMBODIMENTS

The information processing device, operation control system, and screen data generation program according to an embodiment of the present invention are now explained with reference to the attached drawings.

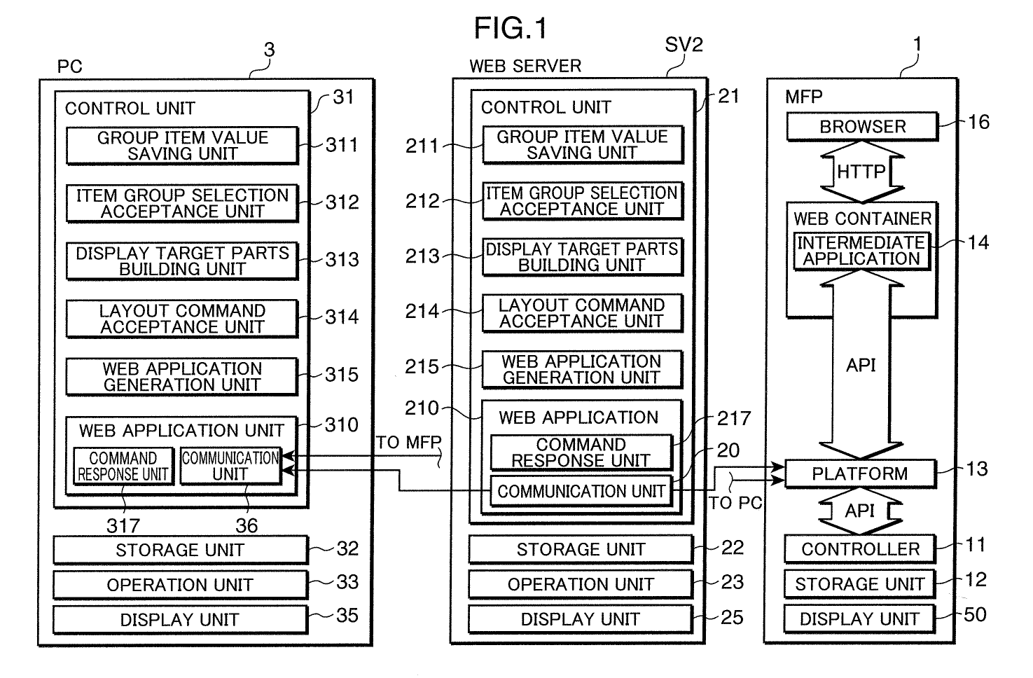

FIG. 1 is a diagram showing a configuration that is required for the generation/display processing of a display screen and the operation control of a web server, a personal computer and an image forming apparatus provided to an operation control system. The multifunction machine 1, web server SV 2 and personal computer 3 of the operation control system 10 will be explained as one unit each. However, the number of multifunction machines, web servers, and PCs of the operation control system 10 is not limited to the above.

The multifunction machine 1 as an example of an electrical apparatus and an image forming apparatus comprise various functions such as a copy function, facsimile function, printer function, and scanner function. Moreover, the multifunction machine 1 also comprises a document management function of storing document data of a manuscript that was read with the scanner unit in the internal storage apparatus of the multifunction machine 1, the web server SV 2 that is network-connected to the multifunction machine 1 with a LAN (local area network) or the like, or a storage unit within the PC 3, and reading and printing the print target data that is stored in the internal storage apparatus of the multifunction machine 1, the web server SV 2, and the storage unit in the respective PCs 3. The multifunction machine 1 is equipped with a display unit 50 configured from an LCD (Liquid Crystal Display).

The web server SV 2 stores the screen data of the display screen (hereinafter referred to as the “screen data”) to be displayed on the display unit 50 of the multifunction machine 1, and is able to perform the generation processing of the foregoing display screen and the operation control processing of the multifunction machine 1. The multifunction machine 1 receives, from the web server SV 2, the screen data to be displayed as the display screen on the display unit 50, and displays this on the display unit 50.

The personal computer (hereinafter referred to as the “PC”) 3 is used as a client terminal, and is able to perform the generation processing of the foregoing display screen. However, the PC 3 may also be in charge of the operation control processing of the multifunction machine 1.

The internal configuration of the web server SV 2, the PC 3 and the multifunction machine 1, which is also the configuration that is required for the generation processing and display processing of the screen data, is now explained.

The PC 3 comprises a control unit 31, a storage unit 32, an operation unit 33, a communication unit 36, and a display unit 35. The storage unit 32 is configured from an HDD or the like, and stores the operation control program of the PC 3, and a screen data generation program (web application generation program) according to an embodiment of the present invention. The screen data generation program is stored in a computer readable recording medium. The storage unit 32 stores the foregoing screen data generation program that was read by the control unit 31 from the recording medium via an interface.

The control unit 31 is configured from a CPU or the like, and governs the overall operation control of the PC 3 according to the foregoing operation control program. The control unit 31 also functions as each of the following components by operating according to the foregoing screen data generation program stored in the storage unit 32.

The control unit 31 comprises a group item value storage unit 311, an item group selection acceptance unit 312, a display target parts building unit 313, a layout command acceptance unit 314, a web application generation unit 315, and a web application unit 310 including a command response unit 317 and a communication unit 36.

The group item value storage unit 311 stores an item group to be displayed on the display unit 50 of the multifunction machine 1 in order to accept additional operation commands from the user when the user operates an operational image (an image that is displayed as an operation button or the like on the display screen of the display unit 50 in the multifunction machine 1 for accepting a command from the user).

The respective item groups stored in the group item value storage unit 311 are given a group name such as “color setting,” “resolution,” “manuscript size,” and “file format.” The name of the item group shows the contents of the operation command that is accepted by using the display target parts described later as the operation button. The item group is configured from an item group including one or more acceptable items.

The item shows a further detailed operation setting of the foregoing operation command that is accepted with the operation of the display target parts. For example, as items that are associated with an item group that is given the name of “color setting,” provided are “automatic (color/gray scale),” “automatic (color/monotone),” “full color,” “gray scale,” “monotone binary” and the like for performing a further detailed setting for the “color setting.” If the user performs an operation based on an image when such image showing the item is displayed on the display unit 50 of the multifunction machine 1, the contents of the operation setting of the item that is shown with the image are registered in the multifunction machine 1 (details regarding the registration processing are described later).

The group item value storage unit 311 acquires, from the multifunction machine 1, and accumulates the foregoing items and information of the item group that is configured with these items. The group item value storage unit 311 may store the foregoing items and the information of the item group that is configured from these items in advance, but it may also make an inquiry to the controller 11 of the multifunction machine 1, via the communication unit 36, regarding the foregoing items and item group as the operation setting that can be made with the multifunction machine 1, and acquire, from the controller 11, and store the foregoing items and information of the item group as needed. Consequently, even in cases where a plurality of types of multifunction machines are network-connected, the group item value storage unit 311 is able to acquire, from the multifunction machines, all items corresponding to such plurality of types of multifunction machines and information of the item group at the required timing, and reduce the amount of information that is accumulated in the group item value storage unit 311.

The item group selection acceptance unit 312 accepts, from the operator, a selection command for selecting the operator intended item group among the item groups stored in the group item value storage unit 311. For example, when the operator designates a specific item group among the item groups stored in the group item value storage unit 311 by operating the operation unit 33 configured from a mouse pointer, a keyboard, a touch panel or the like, the item group selection acceptance unit 312 accepts the designated item group as the item group that was selected by the operator.

The display target parts building unit 313 associates, with the foregoing operational image, and store the item group showing the selection command accepted by the item group selection acceptance unit 312. In other words, the display target parts building unit 313 builds, as the display target parts, a combination of the foregoing operational image and the item group shown with the selection command that was accepted by the item group selection acceptance unit 312. The image data of the operational image to be used in building the display target parts is retained in the display target parts building unit 313.

For example, the display target parts building unit 313 associates, with an operational image of a predetermined shape, one of the item groups shown with a group name such as “color setting,” “resolution,” “manuscript size,” and “file format” and stores the same.

The layout command acceptance unit 314 accepts from the operator, for instance, based on an operation of the operation unit 33, a layout command for designating the arrangement of the display target parts built with the display target parts building unit 313 in the display screen. For example, when a background image of the display screen is simulatively displayed as a part of the customization acceptance screen described later on the display unit 25 of the PC 3, if the operator uses the operation unit 33 and designates an arbitrary location in such background image, the layout command acceptance unit 314 accepts the designated location as the arrangement location of the foregoing designated display target parts.

The web application generation unit 315 generates a web application comprising screen data of the display screen (display screen that is displayed on the display unit 50 of the multifunction machine 1) containing contents that are set with the display target parts built with the display target parts building unit 313, and the layout command accepted by the layout command acceptance unit 314. Specifically, the web application generation unit 315 generates a web application comprising screen data of the display screen in which the display target parts built at the position on the background image shown with the layout command are arranged on the background image of the display screen to be displayed on the display unit 50 of the multifunction machine 1. The web application that is generated with the web application generation unit 315 is stored in the storage unit 32. The storage unit 32 is an example of the web application storage unit referred to in the claims.

Specifically, when the operator performs the foregoing item group selection with the item group selection acceptance unit 312 and the foregoing layout command with the layout command acceptance unit 314, the operator is able to customize and create the display screen to be displayed on the display unit 50 of the multifunction machine 1 so that the intended display target parts are arranged at the intended positions based on the web application generation processing to be performed by the web application generation unit 315.

The web application unit 310 is realized by the control unit 31 being operated according to the foregoing web application stored in the storage unit 32. The web application unit 310 receives a request from the browser (Web browser) 16 loaded in the multifunction machine 1 and provides dynamic contents. The web application unit 310 comprises a command response unit 317.

The command response unit 317 receives an output command regarding the foregoing screen data of the web application generated with the web application generation unit 315 from the multifunction machine 1 via the communication unit 36, and reads the screen data shown with the received output command from the storage unit 32 and converts it into HTML format. The command response unit 317 causes the communication unit 36 to send the screen data that was converted into HTML format to the web server SV 2 or the multifunction machine 1. If the server management-type processing described later is to be performed by storing the web application and its screen data in the storage unit 22 of the web server SV 2, the command response unit 217 of the web server SV 2 may perform the processing for converting the screen data into HTML format.

Moreover, if the communication unit 36 (parts selection command reception unit) receives, from the multifunction machine 1, a parts selection command showing the display target parts selected by the user with the multifunction machine 1, the command response unit 317 analyzes the item group associated with the display target parts shown with the received parts selection command based on the correspondence relationship of the operational image and the item group shown with the foregoing screen data stored in the storage unit 32. The command response unit 317 sends the item group that was obtained based on the foregoing analysis from the communication unit 36 to the multifunction machine 1.

Moreover, if the communication unit 36 receives an item selection command sent from the multifunction machine 1 when the user operates an image shown with the foregoing item with the multifunction machine 1, the command response unit 317 analyzes the setting contents or operation corresponding to the item shown with the received item selection command based on information concerning the operational image and item group contained in the foregoing screen data of the web application stored in the storage unit 32. The command response unit 317 sends the setting contents or operation obtained from the foregoing analysis from the communication unit 36 to the multifunction machine 1.

In addition, the group item value storage unit 311 stores, for each item group, the acceptable items to become a prohibition target of display according to the combination of the contents of the operation setting that has been previously registered based on an operation by a user with the multifunction machine 1, and the respective item groups stored in the group item value storage unit 311. The command response unit 317 determines whether there is an acceptable item that has become a prohibition target of display in relation to the previously registered operation setting based on information of the acceptable items to become the prohibition target of display which is stored for each item group by the group item value storage unit 311. If the command response unit 317 determines that there is an acceptable item that has become a prohibition target of display, it deems that such prohibited acceptable item has been excluded from the item group associated with the display target parts.

The operation unit 33 is configured from a mouse pointer, a keyboard, a touch panel or the like, and accepts various commands from the operator based on operations by the operator.

The communication unit 36 is provided as a part of the web application unit 310, and inputs and outputs data between the web server SV 2 and the multifunction machine 1 via a network. The communication unit 36 outputs the screen data that was read from the storage unit 32 by the command response unit 317 to the web server SV 2 or the multifunction machine 1.

The display unit 35 is configured from an LCD (Liquid Crystal Display) or the like, and displays various images based on the display control performed by the control unit 31.

Moreover, the web server SV 2 comprises a communication unit 20, a control unit 21, a storage unit 22, an operation unit 23, and a display unit 25. The storage unit 22 is configured from an HDD or the like, and stores the operation control program of the web server SV 2 and the screen data generation program according to an embodiment of the present invention.

The communication unit 20 is provided as a part of the web application unit 210, and inputs and outputs data between the PC 3 and the multifunction machine 1 via a network. The communication unit 20 outputs to the multifunction machine 1 the screen data that was read from the web application of the screen data storage unit 216 by the command response unit 217.

The control unit 21 comprises a group item value saving unit 211, an item group selection acceptance unit 212, a display target parts building unit 213, a layout command acceptance unit 214, a web application generation unit 215, and a web application unit 210 including a command response unit 217 and a communication unit 20. Incidentally, unless a specific explanation is provided, the respective units of from the group item value saving unit 211 to the command response unit 217 shall have the same functions as the respective components from the group item value storage unit 311 to the command response unit 317 in the PC 3.

The command response unit 217 has the same function as the command response unit 317 of the PC 3, and further stores the foregoing screen data sent from the PC 3 in the storage unit (an example of the web application storage unit in the claims) 22. Accordingly, the storage unit 22 of the web server SV 2 stores, in addition to the web application generated with the web application generation unit 215, the web application that was generated in the PC 3 and sent from the PC 3. The command response unit 217 receives an output command of the screen data of the web application stored in the storage unit 22 from the multifunction machine 1 via the communication unit 20, and reads the screen data shown with the received output command from the web application of the storage unit 22.

The operation unit 23 is configured from a mouse pointer, a keyboard, a touch panel or the like, and accepts various commands from the operator based on operations by the operator. Specifically, in this embodiment, the operator is able to create a display screen to be displayed on the display unit 50 of the multifunction machine 1 with either the PC 3 or the web server SV 2 by operating the operation unit 33 of the PC 3 or the operation unit 23 of the web server SV 2.

Note that, in this embodiment, the screen data generation program is stored in both the PC 3 and the web server SV 2, and both the control unit 31 of the PC 3 and the control unit 21 of the web server SV 2 function as the foregoing group item value storage unit, the item group selection acceptance unit, the display target parts building unit, the layout command acceptance unit, the web application generation unit, the storage unit as the web application storage unit, and the web application unit. However, the present invention is not necessarily limited to the foregoing configuration.

For example, the configuration may also be such as the PC 3 performs the processing up to generating the web application with the web application generation unit 315, the generated web application is sent to the web server SV 2 via the communication unit 36, the storage unit 22 of the web server SV 2 stores the generated web application, and the command response unit 217 reads the screen data showing the output command from the web application of the storage unit 22 according to the screen data output command from the multifunction machine 1 and causes the communication unit 20 to send this to the multifunction machine 1 so that the web server SV 2 performs the server management-type processing of managing the foregoing screen data.

In the case of this server management-type processing, the information processing device according to the present invention is configured from both the PC 3 and the web server SV 2, and it will suffice so as long as the PC 3 and the web server SV 2 comprise the respective components that are respectively required for the foregoing server management-type processing among the foregoing group item value storage unit, the item group selection acceptance unit, the display target parts building unit, the layout command acceptance unit, the web application generation unit, the storage unit as the web application storage unit, and the web application unit.

Specifically, it will suffice if the information processing device referred to in the claims to comprise either the PC 3 or the web server SV 2 on the one hand, and it will suffice if the information processing device configured from both the PC 3 and the web server SV 2 comprises the group item value storage unit, the item group selection acceptance unit, the display target parts building unit, the layout command acceptance unit, the web application generation unit, the storage unit as the web application storage unit, and the web application unit.

Meanwhile, the multifunction machine 1 comprises a controller 11, a storage unit 12, a platform 13, an intermediate application 14, a web browser 16, and a display unit 50.

The controller 11 governs the overall operation control of the multifunction machine 1. The controller 11 is provided as firmware, and executes the basic functions of the multifunction machine 1 such as the scanning operation, scanned data sending, printing, data access, system configuration, network communication, JOB control, and data registration.

The platform 13 is a platform running the API (Application Programming Interface) or the like. The platform 13 is responsible for relaying the controller 11 and the API.

The platform (reception unit, parts selection command output unit) 13 acquires display data (HTML format data) of the display screen to be displayed on the display unit 50 and various commands from the web server SV 2 or the PC 3 via a network such as a LAN. The platform 13, under the control of the controller 11, sends the parts selection command accepted with the web browser 16 or the output command of the foregoing screen data to be displayed on the display unit 50 to the PC 3 or the web server SV 2.

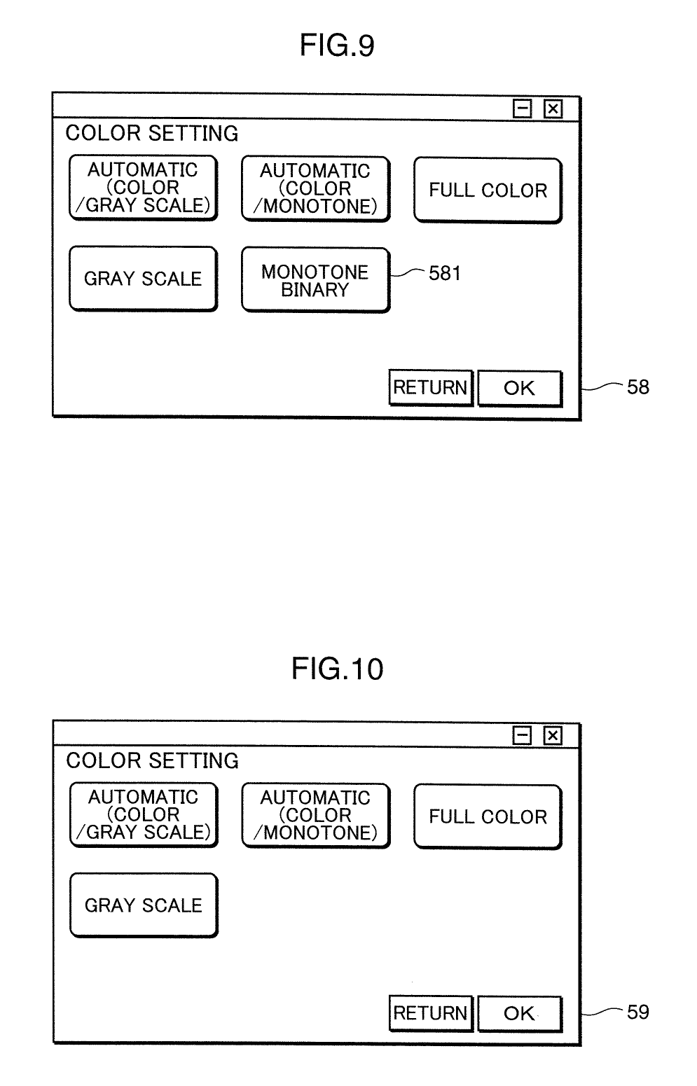

When the controller 11 is displaying, for example, the display screen (for instance, FIG. 9 described later) or the like on the display unit 50, if the user uses a touch panel function or the like to push the “color setting” button 541, it makes an inquiry to the PC 3 or the web server SV 2 via the platform 13. Specifically, the controller 11 sends the parts selection information showing that the “color setting” button 541 (an example of the display target parts) has been designated by the user via the platform 13 from the platform 13 to the PC 3 or the web server SV 2. The controller 11 is an example of the parts selection command acceptance unit referred to in the claims and the platform 13 is an example of the parts selection command output unit referred to in the claims.

The storage unit 12 is configured from an HDD or the like, and stores an operation control program for causing the controller 11 to function as each of the foregoing components, programs of the web browser 16, and so on. The CPU as the central processing unit of the multifunction machine 1 functions as the controller 11, the web browser 16 and the like by operating according to the respective programs stored in the storage unit 12.

The intermediate application 14 performs intermediate processing to enable the platform 13 to process, with the web browser 16, the screen data in the HTML format that the platform 13 received from the PC 3 or the web server SV 2.

The web browser (Web browser) 16 displays the screen data in the HTML format on the display unit 50. In this embodiment, the web browser 16 functions as the operation unit to accept the command input operation from the user via the touch panel function of the display unit 50 while the display screen is being displayed. Specifically, the web browser 16 functions as the parts selection command acceptance unit for accepting a parts selection command for selecting the display target parts displayed in the display screen while the display screen is being displayed on the display unit 50. Specifically, the web browser 16 displays, on the display unit 50, a command input screen to the web application unit 210 of the web server SV 2 or the web application unit 310 of the PC 3.

An API is an interface for executing the foregoing basic functions of the multifunction machine 1 to be executed by the controller 11 of the multifunction machine 1 from other than the firmware. The API accesses the controller 11 in the firmware of the multifunction machine 1 through the platform 13 of the multifunction machine 1 and executes the foregoing basic functions of the multifunction machine 1.

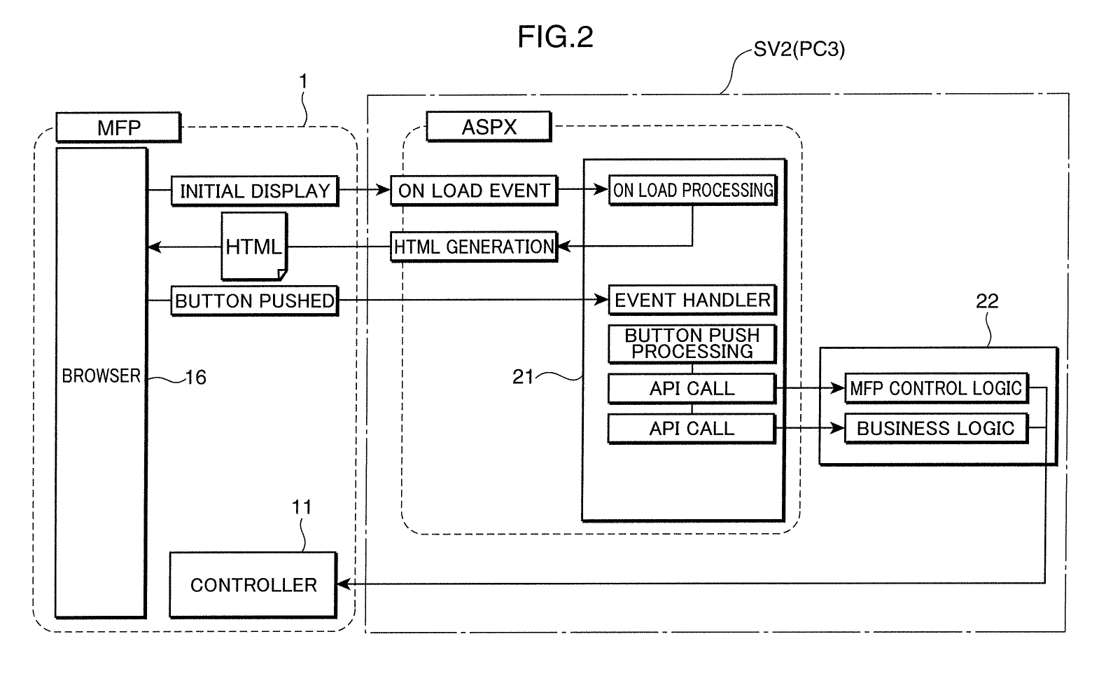

The screen display processing and operation control in the operation control system 10 are now explained in further detail. FIG. 2 is a conceptual diagram showing the screen display processing and the operation control in the operation control system 10. Here, the screen data generated with the PC 3 is stored in the storage unit 22 of the web server SV 2, and the operation control of the multifunction machine 1 based on the pushing operation by the user of the display target parts in the display screen displayed on the display unit 50 of the multifunction machine 1 is explained by taking the server management-type processing to be performed between the multifunction machine 1 and the web server SV 2 as an example.

When the power of the multifunction machine 1 is turned on, the web browser 16 displays a predetermined initial display screen on the display unit 50.

When the multifunction machine 1 needs screen data to be displayed as the display screen on the display unit 50 such as when switching the display screen, the platform 13 sends an output command of the screen data to be displayed as the display screen on the display unit 50 to the web server SV 2 under the control of the web browser 16 and the controller 11.

The command response unit 217 of the web application unit 210 provided to the web server SV 2 receives the foregoing output command as an on load event from the multifunction machine 1. The command response unit 217 performs the on load processing based on the on load event. Specifically, the command response unit 217 reads the screen data of the display screen shown with the output command from the storage unit 22, converts the screen data into HTML format, and sends this from the communication unit 20 to the platform 13 of the multifunction machine 1.

In the multifunction machine 1, the platform 13 receives the foregoing screen data in HTML format and the web browser 16 displays the received screen data on the display unit 50.

Here, while the foregoing display screen is being displayed by the web browser 16, if the user pushes any one of the display buttons (display target parts, or images showing the foregoing items function as the display buttons) in the display screen based on an operation using the touch panel function, the parts selection command showing the pushed display button is accepted by the web browser 16, and the parts selection command is sent from the web browser 16 to the command response unit 217 of the web server SV 2 via the platform 13, the communication unit 20 and the like.

The command response unit 217 of the web server SV 2 analyzes the item group, item or operation associated with the display button shown with the parts selection command (display target parts or images showing the foregoing items) based on the screen data of the web application stored in the storage unit 22.

When the command response unit 217 analyzes the item group, item or operation associated with the display button shown with the parts selection command, in order to cause the multifunction machine 1 to display the image corresponding to the analyzed item group or item or execute the analyzed operation, the command response unit 217 calls (API call) the API corresponding to the operation of displaying the item group or item or the API corresponding to the analyzed operation from the multifunction machine control logic (configured from a control logic group for controlling the operation of the respective operational mechanisms of the multifunction machine 1) shown with the middleware stored in the storage unit 22, and causes the communication unit 20 to send the API to the multifunction machine 1. Here, if the analyzed operation is an operation of the respective operational mechanisms of the multifunction machine 1 but is an operation that has been newly created and set by the operator, the command response unit 217 calls the API corresponding to the operation based on a business logic (configured from a control logic group of the operation that was newly created and set by the operator) shown with the middleware stored in the storage unit 22, and causes the communication unit 20 to send the API to the multifunction machine 1.

If the analyzed operation is a predetermined operation that is an operation by an apparatus other than the multifunction machine 1, the command response unit 217 calls the API corresponding to the operation based on a business logic (configured from a control logic group of the predetermined operation other than the multifunction machine 1) shown with the middleware stored in the storage unit 22, and causes the communication unit 20 to send the API to the apparatus other than the multifunction machine 1. If it is necessary to send an image data (screen data of the display screen, data of an image showing the item group or item) to the multifunction machine 1 in order to perform the analyzed display or operation, the command response unit 217 sends the required image data together with the foregoing API.

When the platform 13 of the multifunction machine 1 receives the foregoing API (and image data), the API (and image data) accesses the controller 11 in the firmware of the multifunction machine 1 through the platform 13, and executes an operation corresponding to the API (and image data).

Specifically, the controller 11 of the multifunction machine 1 performs the foregoing operation by the command response unit 217 sending the screen data of the display screen according to information showing the foregoing prohibition target stored in the group item value storage unit 211 from the communication unit 20 to the multifunction machine 1, the web browser 16 (and Java (registered trademark) Script engine) of the multifunction machine 1 displaying such screen data on the display unit 50, and the command response unit 217 of the web server SV 2 analyzing the operation corresponding to the display target parts selected with the operation by the user that was performed based on the display screen of the display unit 50, and sending the analyzed operation from the communication unit 20 to the multifunction machine 1.

In the case of PC management-type processing; specifically, when the PC 3 is to generate screen data with the web application generation unit 315 and store the generated screen data in the storage unit 32, and the command response unit 317 is to read the screen data shown with the output command from the storage unit 32 according to the screen data output command from the multifunction machine 1 and cause the communication unit 36 to send this to the multifunction machine 1, the PC 3 will perform the processing to be performed by the web server SV 2 that was explained with reference to FIG. 2.

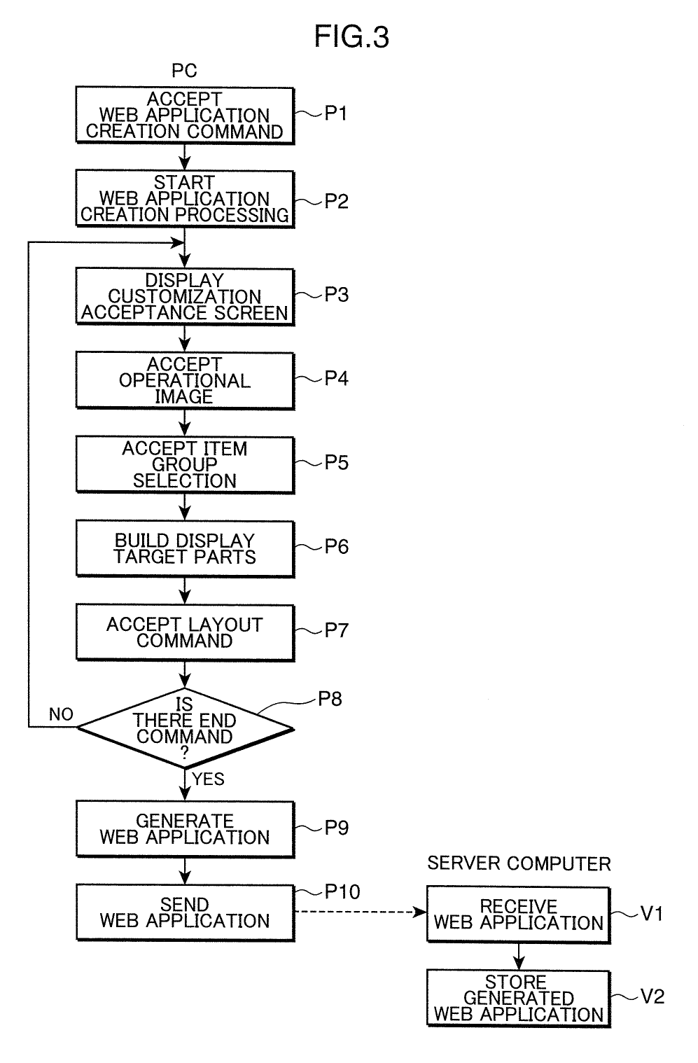

FIG. 3 is a diagram showing the processing upon the PC 3 and the web server SV 2 generating a web application. The foregoing server management-type processing is also taken as an example in this processing. Although the web application generation processing is explained below, since the web application comprises screen data of the display screen to be displayed as the display screen of the multifunction machine 1, the web application generation processing is also the generation processing of the screen data of the display screen to be displayed as the display screen of the multifunction machine 1.

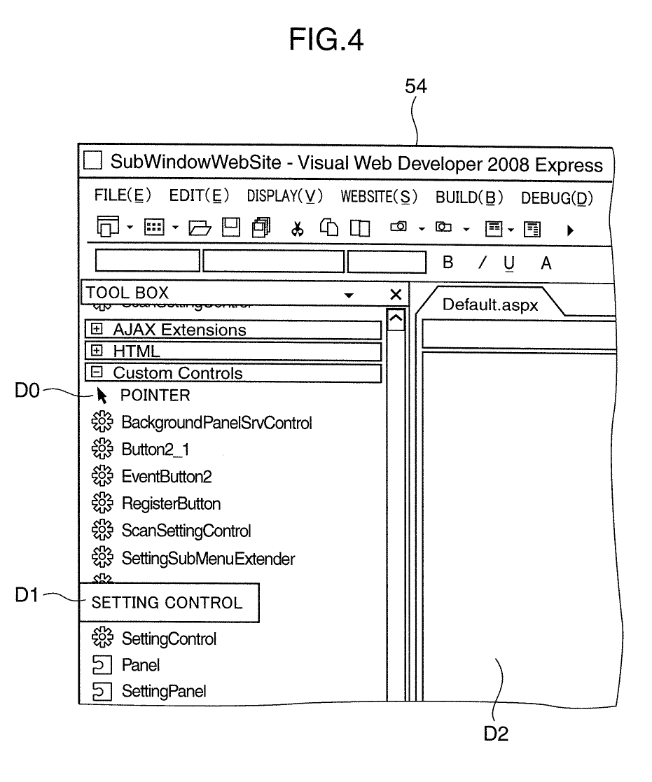

The operator inputs the web application generation command, for example, by operating the operation unit 33 of the PC 3. When the input of the web application generation command by the operator is accepted by the control unit 31 (P1), the control unit 31 starts the display screen creation processing (web application generation processing) based on the screen data generation program (web application generation program) stored in the storage unit 32 (P2). For example, the control unit 31 displays the display data of the customization acceptance screen 54 as shown with the example of FIG. 4 on the display unit 35 (P3). In the customization acceptance screen 54, a plurality of operational images retained by the web application generation program are displayed as a list of function names of the multifunction machine 1 in the tool box area D0.

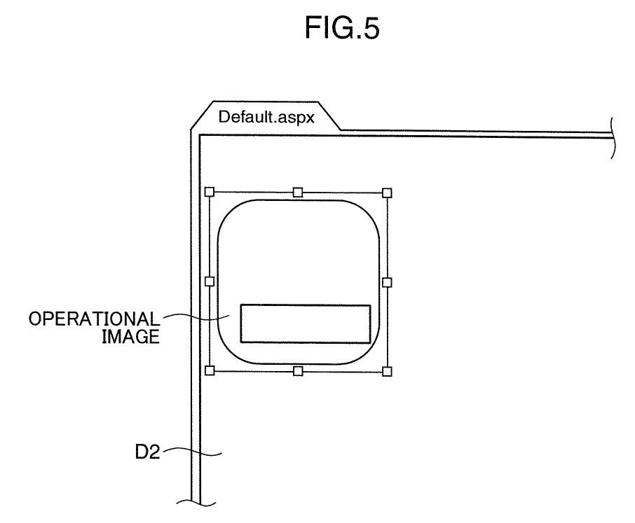

When the command for selecting an operational image shown with the image name displayed on the display portion D1 is accepted by the control unit 31 based on the operator's operation of designating the “setting control” display portion D1 of the customization acceptance screen 54 by left-clicking the operation unit 33 configured from a mouse pointer or the like (P4), the control unit 31 displays the display area D2 configuring a part of the customization acceptance screen 54 as shown in FIG. 5, and displays the designated operational image in the display area D2.

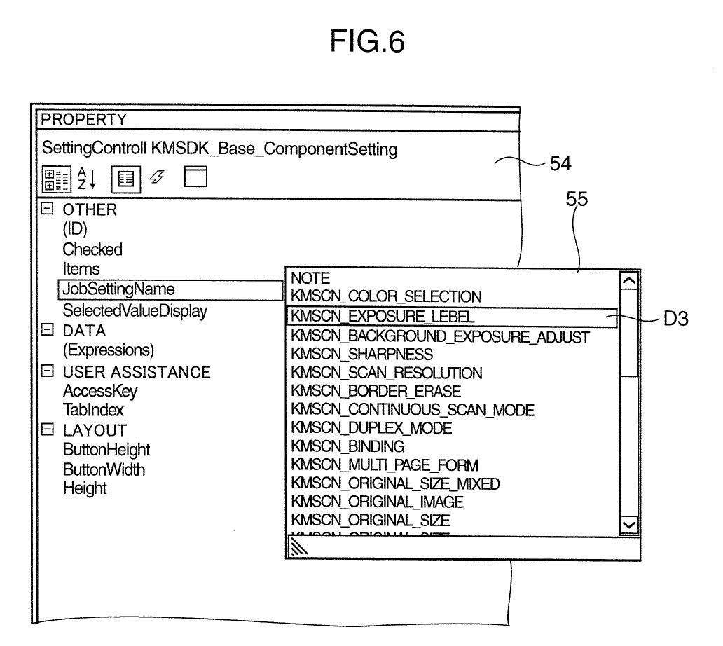

In addition, based on the operator's operation of right-clicking the operation unit 33 configured from a mouse pointer or the like, the control unit 31 displays the item group name list screen 55 on the display unit 35, for example, as shown in FIG. 6. For example, the control unit 31 displays, in an overlapping manner, the item group name list screen 55 on the customization acceptance screen 54 that is already being displayed.

The operator's intended item group name is designated by the display portion D3 in which the name of the intended item group is displayed in the item group name list screen 55 by the operator operating the operation unit 33 while the item group name list screen 55 is being displayed on the display unit 35, and, when the command designating the item group is accepted by the item group selection acceptance unit 312 (P5), the display target parts building unit 313 builds the display target parts by associating the item group shown with the designated command with the selected operational image, and stores the display target parts that were built based on the combination of the item group and the operational image (P6). Here, the control unit 31 displays, in the area D2, the name of the designated item group as the display target parts by overlapping it on the operational image.

When the operator performs the drag & drop operation with the operation unit 33 configured from a mouse pointer or the like and moves the display target parts displayed in the area D2 to the display position of the display target parts in the area D2, the position of the display target parts that was changed in the area D2 based on the foregoing operation is set as a layout command showing the position of the display target parts in the display screen, and the layout command is accepted by the layout command acceptance unit 314 (P7).

The processing of P3 to P7 is repeated for creating a plurality of display target parts until the operator uses a mouse or the like to click an end button (not shown) in the customization acceptance screen 54 of the PC 3 and the web application generation end command from the operation is input (P8).

When the foregoing web application generation end command from the operator is input and accepted by the control unit 31 (YES at P8), the web application generation unit 315 generates a web application according to the display target parts that were created up to that point in time and the layout command regarding the respective display target parts (P9).

After the web application is generated by the web application generation unit 315, the command response unit 317 sends the generated web application from the communication unit 36 to the web server SV 2 (P10).

When the generated web application is received by the communication unit 20 in the web server SV 2 (V1), the command response unit 217 causes the web application to be stored in the storage unit 22 (V2).

In the case of PC management-type processing, V1 and V2 are not performed, and, after the web application is generated by the web application generation unit 315, the generated web application is stored in the storage unit 32.

Moreover, if the web server SV 2 is to perform all processes from the generation of the web application to the storage of the web application, the processing from P1 to P9 is performed by the web server SV 2, and the generated web application is stored in the storage unit 22.

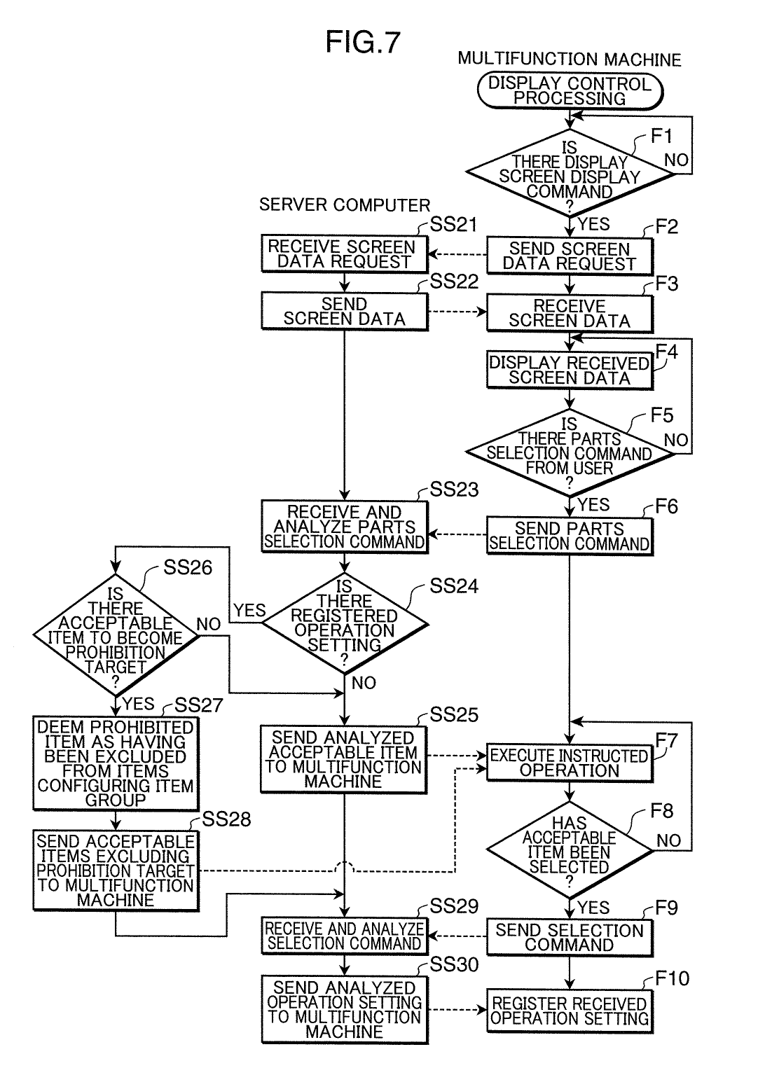

The display processing of the display screen on the display unit 50 of the multifunction machine 1 using the foregoing generated web application by the operation control system 10, and the operation execution control of the multifunction machine 1 based on the operation execution command from the user are now explained. FIG. 7 is a flowchart showing the display processing of the display screen on the display unit 50 of the multifunction machine 1 using the foregoing generated web application by the operation control system 10, and the operation execution control of the multifunction machine 1 based on the operation execution command from the user. The server management-type processing is also taken as an example in the ensuing explanation.

If the web server SV 2 is connected to a plurality of multifunction machines 1, it is able to perform the following processing with any one of the connected multifunction machines 1 and display the display screen on the display unit 50 of each multifunction machine 1 and perform operation execution control of the multifunction machine 1.

If it becomes necessary to display the display screen on the display unit 50 in the multifunction machine 1 based on the user's operation of an operation unit not shown (YES at F1), the controller 11 sends an output command to the web application unit 210 of the web server SV 2 via the platform 13 or the like to the effect of sending the screen data of the display screen corresponding to the operation (F2).

When the web server SV 2 receives the output command of the screen data from the communication unit 20 (SS21), the command response unit 217 reads the screen data showing the output command from the web application of the storage unit 22, converts the read screen data into HTML format data, and thereafter causes the communication unit 20 to send such data to the multifunction machine 1 that sent the output command (SS22).

When the platform 13 of the multifunction machine 1 receives the screen data as HTML format data from the web server SV 2 (F3), the web browser 16 displays the screen data on the display unit 50 (F4).

If any one of the display buttons (display target parts) of the display screen displayed on the display unit 50 is pushed based on the user's operation using the touch panel function or the like while the foregoing display screen is being displayed by the web browser 16 (YES at F5), a parts selection command showing the pushed display button (display target parts) is sent to the web application unit 210 of the web server SV 2 from the web browser 16 via the platform 13 (F6).

When the communication unit 20 receives the parts selection command in the web server SV 2, the command response unit 217 analyzes the item group associated with the display button (display target parts) shown with the parts selection command based on the screen data (screen data of the display screen including the display target parts shown with the parts selection command) of the web application stored in the storage unit 22 (SS23).

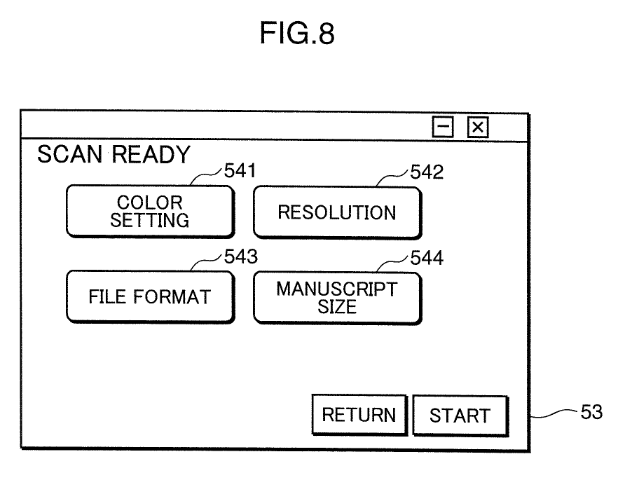

An example of the display screen to be displayed on the display unit 50 of the multifunction machine 1 is shown in FIG. 8. FIG. 8 shows an example of the display screen configured from screen data including four operation buttons 541, 542, 543, 544 as the display target parts. When the “color setting” button 541 of the detailed setting screen 53 in FIG. 8 is pushed by the user and the pushing of the operation button is accepted by the web browser 16, the parts selection command showing the pushed display button (display target parts) is sent to the web server SV 2. In the web server SV 2, based on the screen data of the web application of the storage unit 22, the command response unit 217 analyzes that the item group associated with the display target parts shown with the parts selection command is “color setting,” and the item group configuring the item group of “color setting” is, for example, “automatic (color/gray scale),” “automatic (color/monotone),” “full color,” “gray scale,” and “monotone binary.”

Subsequently, the command response unit 217 determines whether there is an operation setting that has been previously registered based on the user's operation of the web browser 16 in the multifunction machine 1 at such point in time (SS24).

If the command response unit 217 determines that there is no operation setting that has been previously registered (NO at SS24), the command response unit 217 sends the API corresponding to the operation for displaying the item group and the screen data of the display screen including the images showing the item group from the communication unit 20 to the multifunction machine 1 in order to cause the multifunction machine 1 to display the images corresponding to all items configuring the item group that was analyzed at SS23 (SS25).

If the command response unit 217 determines that there is an operation setting that has been previously registered (YES at SS24), the command response unit 217 determines whether there is an acceptable item that became a prohibition target of display according to the combination of the previously registered operation setting and the item group analyzed at SS23 (SS26). The group item value storage unit 311 stores, for each item group, the acceptable items that became prohibition targets of display according to the combination of the previously registered operation setting and the respective item groups stored in the group item value storage unit 311. The command response unit 217 determines whether there is an acceptable item that became a prohibition target of display in relation to the previously registered operation setting based on the information of the acceptable items that became the prohibition targets of display stored for each of the item groups.

Here, if the command response unit 217 determines that there is an acceptable item that became a prohibition target of display in relation to the previously registered operation setting based on the information of the acceptable items that became the prohibition targets of display stored by the group item value storage unit 311 for each of the item groups (YES at SS26), it deems that the prohibited acceptable item has been excluded from the item group configuring the item group analyzed at SS23 (SS27).

Meanwhile, if the command response unit 217 determines that there is no acceptable item that became a prohibition target of display in relation to the previously registered operation setting based on the information of the acceptable items that became the prohibition targets of display stored for each of the item groups (NO at SS26), the processing of SS25 is performed.

The command response unit 217 sends the API corresponding to the operation for displaying the respective items and the screen data of the display screen including the images showing the item group from the communication unit 20 to the multifunction machine 1 in order to cause the multifunction machine 1 to display images corresponding to the items other than the prohibited acceptable items (SS28). Consequently, since it is possible to avoid displaying the acceptable items that do not need to be displayed based on the designation even if other image parts are designated after the acceptance of the operation in the relationship with the previously set contents based on the operation of the acceptable items, it is possible to display a display screen which the user is able to perform the truly necessary operations.

The controller 11 (and web browser 16) of the multifunction machine 1 receive the API (and image data) via the platform 13 and execute the instructed operation according to the received API (F7). For example, the controller 11 and the web browser 16 use the screen data that was sent together with the API and display each of the analyzed item groups on the display unit 50 according to the API.

If there is no item to become a prohibition target upon displaying the acceptable items (NO at SS24, NO at SS26, SS25), for instance, if the item group is “color setting,” the display screen 58 including all items “automatic (color/gray scale),” “automatic (color/monotone),” “full color,” “gray scale,” and “monotone binary” configuring the “color setting” is displayed on the display unit 50 of the multifunction machine 1 (refer to FIG. 9).

Meanwhile, if there is an item to become a prohibition target upon displaying the acceptable item (YES at SS24, YES at SS26, SS27, SS28), for instance, if the “JPEG” of the acceptable item configuring the “file format” is set based on the operator's operation of the item group of “file format” at such point in time, and the item group associated with the display target parts shown with the parts selection command received at SS23 is “color setting,” the command response unit 217 deems that “monotone binary” stored as the prohibition target of the acceptable item “JPEG” has been excluded from the items (“automatic (color/gray scale),” “automatic (color/monotone),” “full color,” “gray scale,” “monotone binary”) configuring the “color setting,” and sets the analyzed acceptable items only as “automatic (color/gray scale),” “automatic (color/monotone),” “full color,” and “gray scale.” Accordingly, in the foregoing case, as shown in FIG. 10, the display screen 59 only including the “automatic (color/gray scale),” “automatic (color/monotone),” “full color,” and “gray scale” is displayed on the display unit 50 of the multifunction machine 1.

After the file format is set to JPEG based on the pushing of the “file format” button 543 of the detailed setting screen 53 of FIG. 8 and the user's operation in the subsequent screen that is displayed based on the foregoing pushing operation, if the user sets the color setting to monotone binary based on the pushing operation of the “color setting” button 541 of the detailed setting screen 53 shown in FIG. 8 and the pushing operation of the “monotone binary” button 581 shown in FIG. 9, the command response unit 217 (1) may mandatorily change the setting of the file format to TIFF that can be set monotone binary of color setting according to information of the prohibition target, and (2) read the image data showing a message to the effect of setting the file format to TIFF from the web application of the storage unit 22 and converting it into an HTML format, send the image data from the communication unit 20 to the multifunction machine 1, and the web browser 16 of the multifunction machine 1 may display the image data on the display unit 50.

If any one of the display buttons (images showing the acceptable items) of the display screen displayed on the display unit 50 is pushed with the user's operation using the touch panel function or the like while the display screen including images showing the acceptable items is being displayed by the web browser 16 in the multifunction machine 1 (YES at F8), a selection command showing the pushed display button (image showing the acceptable item) is sent from the web browser 16 to the web server SV 2 via the platform 13 (F9).

If the communication unit 20 receives the selection command in the web server SV 2, the command response unit 217 analyzes the item associated with the display button (image showing the acceptable item) shown with the selection command based on the screen data stored in the storage unit 22 (screen data of the display screen including the acceptable item shown with the selection command) (SS29).

Subsequently, the command response unit 217 sends the information of the operation setting shown with the analyzed item from the communication unit 20 to the multifunction machine 1 (SS30). For example, if the analyzed item is the operation setting of “full color,” the command response unit 217 sends information showing the operation setting of “full color” from the communication unit 20 to the multifunction machine 1.

With the multifunction machine 1, if the platform 13 receives the information showing the foregoing operation setting, the controller 11 stores (registers) the contents of the operation setting in a memory or the like not shown in order to operate the respective operational mechanisms based on the operation setting, and performs the operation control based on the foregoing operation setting (F10).

Specifically, if a plurality of operation settings (color setting, resolution setting, file format setting, etc.) are performed as a result of the processing of F1 to F10, SS21 to SS30 being repeated based on the user's operation, the controller 11 of the multifunction machine 1 performs operation control according to the plurality of operation settings (for example, color setting=full color, resolution setting=300 dpi, file format setting=PDF, etc.).

If the web server SV 2 is to perform all processes from the generation of the web application to the storage of the web application, the web server SV 2 performs the same processing as the foregoing processing. In the case of PC management-type processing, the PC 3 performs the processing of SS21 to SS28.

Note that this invention is not limited to the configuration of the foregoing embodiments and can be modified variously. The configuration and processing shown in FIG. 1 to FIG. 10 are merely examples of the embodiments of the present invention, and are not intended to limit the present invention to the foregoing embodiments.

Basically, the present invention is an information processing device for generating screen data to be displayed as a display screen on a display unit provided to an electrical apparatus, including: a group item value storage unit for storing item groups each including one or more acceptable items to be displayed on the display unit for accepting an operation command from a user when an operational image to be displayed on the display screen of the display unit is operated by a user; an item group selection acceptance unit for accepting a designation of an item group selected by an operator among the item groups stored in the group item value storage unit; a display target parts building unit for building display target parts by associating the item group accepted by the item group selection acceptance unit with the operational image; a parts selection command reception unit for receiving, from the electrical apparatus, a parts selection command showing the display target parts selected by a user with the electrical apparatus; an analysis unit for analyzing the item group associated with the display target parts shown with the parts selection command received by the parts selection command reception unit based on the association of the operational image and the item group configuring the display target parts built with the display target parts building unit; an output unit for outputting the item group analyzed with the analysis unit to the electrical apparatus; and an operation setting reception unit for receiving, from the electrical apparatus, an operation setting that has been accepted based on a user's operation of the acceptable item with the electrical apparatus, wherein the group item value storage unit stores, for each of the item groups, an acceptable item to become a prohibition target of display according to a combination of the operation setting received with the operation setting reception unit and the item group, and, when the operation setting is accepted by the operation setting reception unit, the analysis unit deems that the acceptable item to become the prohibition target based on the operation setting has been excluded from the item group associated with the display target parts according to information of the acceptable item to become the prohibition target stored in the group item value storage unit.

The present invention is also a computer readable recording medium with a screen data generation program recorded thereon for causing an information processing device, in order to generate screen data to be displayed as a display screen on a display unit provided to an electrical apparatus, to function as: a group item value storage unit for storing an item group including one or more acceptable items to be displayed on the display unit for accepting an operation command from a user when an operational image to be displayed on the display screen of the display unit is operated by a user; an item group selection acceptance unit for accepting a designation of an item group selected by an operator among the item groups stored in the group item value storage unit; a display target parts building unit for building display target parts by associating the item group accepted by the item group selection acceptance unit with the operational image; a parts selection command reception unit for receiving, from the electrical apparatus, a parts selection command showing the display target parts selected by a user with the electrical apparatus; an analysis unit for analyzing the item group associated with the display target parts shown with the parts selection command received by the parts selection command reception unit based on the association of the operational image and the item group configuring the display target parts built with the display target parts building unit; an output unit for outputting the item group analyzed with the analysis unit to the electrical apparatus; and an operation setting reception unit for receiving, from the electrical apparatus, an operation setting that has been accepted based on a user's operation of the acceptable item with the electrical apparatus, wherein the group item value storage unit stores, for each of the item groups, an acceptable item to become a prohibition target of display according to a combination of the operation setting received with the operation setting reception unit and the item group, and, when the operation setting is accepted by the operation setting reception unit, the analysis unit deems that the acceptable item to become the prohibition target based on the operation setting has been excluded from the item group associated with the display target parts according to information of the acceptable item to become the prohibition target stored in the group item value storage unit.

According to these inventions, when the item group selection from an operator is accepted by the item group selection acceptance unit, the selected item group and the operational image are associated and built as the display target parts by the display target parts building unit, and, when the operation setting accepted with the user's operation of the acceptable item with the electrical apparatus is received by the operation command reception unit of the information processing device, the analysis unit deems that the acceptable item to become a prohibition target in the relationship with the operation setting has been excluded from the item group associated with the operational image configuring the display target parts. Thus, a developer (operator in the specification and claims) to perform operations for customizing the display screen is able to easily create, without requiring complicated operations such as programming, the screen data of a display screen that will not display the acceptable items to be displayed when the display target parts are operated by a user and which do not need to be displayed in the relationship with the operation setting that was previously set by the user with the operation of acceptable items of other display target parts. The operator is thereby able to create a customized display screen according to one's intended display target parts as the operation buttons and the layout thereof with an easy operation.

The present invention is also an information processing device in which the display target parts building unit acquires, from the electrical apparatus, and stores the item group to be the target of association with the operational image.

According to this invention, since an item group configured from acceptable items for accepting operations set with the electrical apparatus is acquired from the electrical apparatus for displaying the foregoing display target parts, it is possible to associate only the truly necessary item groups corresponding to the electrical apparatus with the foregoing operational image.

The present invention is also an information processing device further including: a layout command acceptance unit for receiving, from an operator, a layout command for instructing the arrangement of the display target parts built with the display target parts building unit in the display screen; a web application generation unit for generating a web application comprising screen data of the display screen configured from contents to be set based on the built display target parts and the layout command accepted by the layout command acceptance unit; a web application storage unit for storing the web application generated with the web application generation unit; and a command response unit for receiving an output command of screen data of the web application from the electrical apparatus, and reading the screen data shown from the web application storage unit with the received output command, wherein the output unit outputs the screen data read with the command response unit to the electrical apparatus.

According to this invention, since the output unit outputs the screen data showing the output command received from the electrical apparatus to the electrical apparatus, when the electrical apparatus requires screen data of a prescribed display screen, it is possible to output such required screen data from the information processing device to the electrical apparatus in real time and display the same on the display unit of the electrical apparatus.

The present invention is also an operation control system includes: any one of the foregoing information processing devices; and the electrical apparatus connected to the information processing device; wherein the electrical apparatus includes: the display unit; a reception unit for receiving the screen data output from the output unit of the information processing device; a display control unit for displaying the screen data received with the reception unit on the display unit; a parts selection command acceptance unit for receiving, from a user, a parts selection command for selecting the image part displayed in a display screen when the screen data is displayed as the display screen on the display unit by the display control unit; and a selection command output unit for outputting the parts selection command accepted by the parts selection command acceptance unit to the information processing device, wherein, in the information processing device, the analysis unit analyzes the item group associated with the display target parts shown with the parts selection command received by the parts selection command reception unit based on the association of the operational image and the item group configuring the display target parts built with the display target parts building unit, and the output unit outputs the item group analyzed with the analysis unit to the electrical apparatus.

According to this invention, it is possible to easily create, without requiring complicated operations such as programming, the screen data of a display screen that will not display the acceptable items to be displayed when the display target parts are operated by a user and which do not need to be displayed in the relationship with the operation setting that was previously set by the user with the operation of acceptable items of other display target parts.

This application is based on Japanese Patent application serial No. 2009-183919 filed in Japan Patent Office on Aug. 6, 2009, the contents of which are hereby incorporated by reference.

Although the present invention has been fully described by way of example with reference to the accompanying drawings, it is to be understood that various changes and modifications will be apparent to those skilled in the art. Therefore, unless otherwise such changes and modifications depart from the scope of the present invention hereinafter defined, they should be construed as being included therein.

What is claimed is:

1. An information processing device for generating screen data to be displayed as a display screen on a display unit provided to an electrical apparatus, comprising:
a group item value storage unit for storing item groups each including one or more acceptable items to be displayed on the display unit for accepting an operation command from a user when an operational image to be displayed on the display screen of the display unit is operated by a user;
an item group selection acceptance unit for accepting a designation of an item group selected by an operator among the item groups stored in the group item value storage unit;
a display target parts building unit for building display target parts by associating the item group accepted by the item group selection acceptance unit with the operational image;
a parts selection command reception unit for receiving, from the electrical apparatus, a parts selection command showing the display target parts selected by a user with the electrical apparatus;
an analysis unit for analyzing the item group associated with the display target parts shown with the parts selection command received by the parts selection command reception unit based on the association of the operational image and the item group configuring the display target parts built with the display target parts building unit;
an output unit for outputting the item group analyzed with the analysis unit to the electrical apparatus; and
an operation setting reception unit for receiving, from the electrical apparatus, an operation setting that has been accepted based on a user's operation of the acceptable item with the electrical apparatus,
wherein the group item value storage unit stores, for each of the item groups, an acceptable item to become a prohibition target of display according to a combination of the operation setting received with the operation setting reception unit and the item group, and, when the operation setting is accepted by the operation setting reception unit, the analysis unit deems that the acceptable item to become the prohibition target based on the operation setting has been excluded from the item group associated with the display target parts according to information of the acceptable item to become the prohibition target stored in the group item value storage unit.

2. The information processing device according to claim 1,
wherein the display target parts building unit acquires, from the electrical apparatus, and stores the item group to be the target of association with the operational image.

3. The information processing device according to claim 1, further comprising:
a layout command acceptance unit for receiving, from an operator, a layout command for instructing the arrangement of the display target parts built with the display target parts building unit in the display screen;
a web application generation unit for generating a web application comprising screen data of the display screen configured from contents to be set based on the built display target parts and the layout command accepted by the layout command acceptance unit;
a web application storage unit for storing the web application generated with the web application generation unit; and
a command response unit for receiving an output command of screen data of the web application from the electrical apparatus, and reading the screen data shown from the web application storage unit with the received output command,
wherein the output unit outputs the screen data read with the command response unit to the electrical apparatus.

4. An operation control system, comprising: the information processing device according to claim 1; and the electrical apparatus connected to the information processing device;
wherein the electrical apparatus includes:
the display unit;
a reception unit for receiving the screen data output from the output unit of the information processing device;
a display control unit for displaying the screen data received with the reception unit on the display unit;
a parts selection command acceptance unit for receiving, from a user, a parts selection command for selecting the image part displayed in a display screen when the screen data is displayed as the display screen on the display unit by the display control unit; and
a selection command output unit for outputting the parts selection command accepted by the parts selection command acceptance unit to the information processing device,
wherein, in the information processing device,
the analysis unit analyzes the item group associated with the display target parts shown with the parts selection command received by the parts selection command reception unit based on the association of the operational image and the item group configuring the display target parts built with the display target parts building unit, and
the output unit outputs the item group analyzed with the analysis unit to the electrical apparatus.

5. A computer readable recording medium with a screen data generation program recorded thereon for causing an information processing device, in order to generate screen data to be displayed as a display screen on a display unit provided to an electrical apparatus, to function as:
a group item value storage unit for storing item groups each including one or more acceptable items to be displayed on the display unit for accepting an operation command from a user when an operational image to be displayed on the display screen of the display unit is operated by a user;
an item group selection acceptance unit for accepting a designation of an item group selected by an operator among the item groups stored in the group item value storage unit;
a display target parts building unit for building display target parts by associating the item group accepted by the item group selection acceptance unit with the operational image;
a parts selection command reception unit for receiving, from the electrical apparatus, a parts selection command showing the display target parts selected by a user with the electrical apparatus;
an analysis unit for analyzing the item group associated with the display target parts shown with the parts selection command received by the parts selection command reception unit based on the association of the operational image and the item group configuring the display target parts built with the display target parts building unit;
an output unit for outputting the item group analyzed with the analysis unit to the electrical apparatus; and
an operation setting reception unit for receiving, from the electrical apparatus, an operation setting that has been accepted based on a user's operation of the acceptable item with the electrical apparatus,
wherein the group item value storage unit stores, for each of the item groups, an acceptable item to become a prohibition target of display according to a combination of the operation setting received with the operation setting reception unit and the item group, and, when the operation setting is accepted by the operation setting reception unit, the analysis unit deems that the acceptable item to become the prohibition target based on the operation setting has been excluded from the item group associated with the display target parts according to information of the acceptable item to become the prohibition target stored in the group item value storage unit.
